(19) United States
(12) Patent Application Publication
(10) Pub. No.: US 2026/0109271 A1
(43) Pub. Date: Apr. 23, 2026

(54) VEHICLE AND METHOD OF CONTROLLING MASSAGE UNIT

(71) Applicants: Hyundai Motor Company, Seoul (KR); Kia Corporation, Seoul (KR)

(72) Inventor: Kyoung Jin Chang, Hwaseong (KR)

(21) Appl. No.: 19/205,576

(22) Filed: May 12, 2025

(30) Foreign Application Priority Data
Oct. 17, 2024 (KR) 10-2024-0142130

(51) Int. Cl. B60N 2/00; A61H 15/00; A61H 23/02; B60N 2/90

(52) U.S. Cl. CPC B60N 2/0023; A61H 15/0078; A61H 23/0218; B60N 2/914; B60N 2/976; A61H 2015/0042; A61H 2015/0071; A61H 2201/1246; A61H 2201/1604; A61H 2201/1654; A61H 2201/5005; A61H 2201/5048; A61H 2201/5058; A61H 2201/5084; A61H 2201/5092; A61H 2205/04

(57) ABSTRACT

A vehicle includes a massage unit mounted on a headrest of a vehicle seat to generate pressure and vibration, a transmitting/receiving unit configured to collect image information and voice information about an interior of a vehicle and traveling information about the vehicle, and at least one processor configured to analyze a condition of an occupant and a driving state of the vehicle using the image information and voice information about the interior of the vehicle and the traveling information about the vehicle, and control an operation of the massage unit using the condition of the occupant and the driving state of the vehicle.

### CROSS-REFERENCE TO RELATED APPLICATION

This application claims under 35 U.S.C. § 119 (a) the benefit of Korean Patent Application No. 10-2024-0142130, filed on Oct. 17, 2024, the entire contents of which are incorporated by reference herein.

### BACKGROUND

### 1. Technical Field

A vehicle and a method of controlling a massage unit of a seat of the vehicle are operable to control operation of the massage unit in order to enhance comfort for an occupant of the vehicle.

### 2. Description of the Related Art

A neck massager built into a vehicle seat is used to relieve the fatigue of a driver and a passenger and reduce muscle tension and pain that may occur while driving for long periods of time.

In general, existing neck massagers operate by a method of applying pressure to the neck muscles by rotating a hard massage ball or massage stick. Although the method may provide a massaging effect, the method may give a user uncomfortable tactile feeling, and may actually cause discomfort as the massager may put excessive pressure on the neck, especially when used for long periods of time. In addition, existing devices have limitations in that the devices do not have a vibration function, or even when the devices have the vibration function, do not provide sufficiently strong vibration or have difficulty in implementing various vibration patterns.

In addition, existing vibration seats or neck massagers for vehicles simply provide a certain pattern of vibration, and thus have limitations in providing an optimal massage effect depending on the condition of an occupant or various driving situations.

### SUMMARY

The present disclosure is directed to providing a vehicle capable of providing an optimal massage function in conjunction with traveling data of the vehicle and physical and emotional conditions of an occupant and a method of controlling the same.

According to the present disclosure, a vehicle includes: a massage unit mounted on a headrest of a vehicle seat to generate pressure and vibration; a transmitting/receiving unit configured to collect image information and voice information about an interior of a vehicle and traveling information about the vehicle; and at least one processor configured to: analyze a condition of an occupant and a driving state of the vehicle using the image information and voice information about the interior of the vehicle and the traveling information about the vehicle; and control an operation of the massage unit using the condition of the occupant and the driving state of the vehicle.

According to a further aspect of the present disclosure, there is provided a vehicle including a massage unit mounted on a headrest of a vehicle seat to generate pressure and vibration, a transmitting/receiving unit configured to collect image information and voice information about an interior of a vehicle and traveling information about the vehicle, a first processing unit configured to analyze a condition of an occupant and a driving state of the vehicle using the image information and voice information about the interior of the vehicle and the traveling information about the vehicle, and a second processing unit configured to control an operation of the massage unit using the condition of the occupant and the driving state of the vehicle.

Further, as provided herein, the at least one processor may comprise first, second, and/or additional processing units.

The massage unit may include a pump configured to adjust supply and discharge of air, at least one pneumatic ball configured to provide the pressure to a neck region of the occupant by contracting and expanding in conjunction with an operation of the pump, and at least one voice coil motor configured to provide the vibration to the neck region of the occupant.

The massage unit may further include a support disposed between one end of the voice coil motor and an inner surface of the headrest to support the voice coil motor and a cushioning member disposed at the other end of the voice coil motor.

An interior of the headrest may be filled with a memory foam material.

The second processing unit may generate a first control signal for controlling a pressure intensity and an expansion cycle of the pneumatic ball depending on the condition of the occupant and the driving state of the vehicle.

The second processing unit may generate a second control signal for controlling a vibration intensity, a vibration frequency, and a vibration pattern of the voice coil motor depending on the condition of the occupant and the driving state of the vehicle.

The first processing unit may determine the condition of the occupant including physical and emotional conditions of the occupant using the image information and voice information about the interior of the vehicle.

The first processing unit may determine the driving state using speed information and acceleration information included in the traveling information about the vehicle.

The first processing unit may determine a physical condition of the occupant using acceleration information and accelerator pedal operation information included in the traveling information about the vehicle.

The second processing unit may adjust the pressure of the pneumatic ball inversely proportional to acceleration depending on the driving state.

In addition, according to the present disclosure, a method of controlling a vehicle includes steps of: collecting, by a transmitting/receiving unit, image information and voice information about an interior of a vehicle and traveling information about the vehicle; analyzing, by at least one processor, a condition of an occupant and a driving state of the vehicle using the image information and voice information about the interior of the vehicle and the traveling information about the vehicle; and controlling, by the at least one processor, an operation of a massage unit disposed on a headrest of a vehicle seat using the condition of the occupant and the driving state of the vehicle.

According to another aspect of the present disclosure, there is provided a method of controlling a vehicle, including collecting, by a transmitting/receiving unit, image information and voice information about an interior of a vehicle and traveling information about the vehicle, analyzing, by a first processing unit, a condition of an occupant and a driving state of the vehicle using the image information and voice information about the interior of the vehicle and the traveling information about the vehicle, and controlling, by a second processing unit, an operation of a massage unit disposed on a headrest of a vehicle seat using the condition of the occupant and the driving state of the vehicle.

The massage unit may include a pump configured to adjust supply and discharge of air, at least one pneumatic ball configured to provide pressure to a neck region of the occupant by contracting and expanding in conjunction with an operation of the pump, and at least one voice coil motor configured to provide vibration to the neck region of the occupant.

The massage unit may further include a support disposed between one end of the voice coil motor and an inner surface of the headrest to support the voice coil motor and a cushioning member disposed at the other end of the voice coil motor.

An interior of the headrest may be filled with a memory foam material.

The controlling of the operation of the massage unit may include generating a first control signal for controlling a pressure intensity and an expansion cycle of the pneumatic ball depending on the condition of the occupant and the driving state of the vehicle.

The controlling of the operation of the massage unit may include generating a second control signal for controlling a vibration intensity, a vibration frequency, and a vibration pattern of the voice coil motor depending on the condition of the occupant and the driving state of the vehicle.

The analyzing may include determining the condition of the occupant including physical and emotional conditions of the occupant using the image information and voice information about the interior of the vehicle.

The analyzing may include determining the driving state using speed information and acceleration information included in the traveling information about the vehicle.

The analyzing may include determining a physical condition of the occupant using acceleration information and accelerator pedal operation information included in the traveling information about the vehicle.

The controlling of the operation of the massage unit may include adjusting the pressure of the pneumatic ball inversely proportional to acceleration depending on the driving state.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a view illustrating that a vehicle transmits and receives data by communicating with another device;

FIG. 2 is a diagram showing modules constituting the vehicle according to one embodiment of the present disclosure;

FIG. 3 is a diagram for describing an operation of the vehicle according to the embodiment;

FIG. 4 is a conceptual view of a massage unit according to the embodiment;

FIGS. 5 to 11 are views for describing an operation of a processor according to the embodiment; and

FIG. 12 is a flowchart of a method of controlling a vehicle according to an embodiment.

### DETAILED DESCRIPTION OF EXEMPLARY EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, preferred embodiments of the present disclosure will be described in detail with reference to the accompanying drawings.

However, the technical idea of the present disclosure is not limited to some embodiments to be described but may be implemented in various different forms, and within the scope of the technical idea of the present disclosure, one or more among components in the embodiments may be used by being selectively combined and substituted.

Further, unless specifically defined and described, terms used in the embodiments of the present disclosure (including technical and scientific terms) may be interpreted as meanings which are generally understood by those skilled in the art to which the present disclosure pertains, and commonly used terms such as terms defined in the dictionary may be interpreted in consideration of the contextual meaning of the related art.

The terms used in the embodiments of the present disclosure are for the purpose of describing the embodiments only and are not intended to limit the disclosure.

In the present specification, the singular forms may include the plural forms unless the context clearly dictates otherwise, and when described as “at least one (or one or more) among A, B, and (or) C,” it may include one or more of all possible combinations of A, B, and C.

In addition, in describing a component of embodiments of the present disclosure, terms such as first, second, A, B, (a), (b), etc. may be used.

These terms are only for distinguishing the component from other components, and the essence, sequence, or order of the component is not limited by the terms.

In addition, when a component is described as being “linked,” “coupled,” or “connected” to another component, the component is not only directly linked, coupled, or connected to another component, but also “linked,” “coupled,” or “connected” to another component with still another component disposed between the component and the other component.

Further, when a component is described as being formed or disposed “on (above) or under (below)” of another component, the term “on (above) or under (below)” includes not only when two components are in direct contact with each other, but also when one or more of other components are formed or disposed between the two components. Further, when a component is described as being “on (above) or below (under),” the description may include the meanings of an upward direction and a downward direction based on one component.

Hereinafter, embodiments will be described in detail with reference to the accompanying drawings, but identical or corresponding components are denoted by the same reference numerals regardless of figure numbers, and redundant descriptions thereof will be omitted.

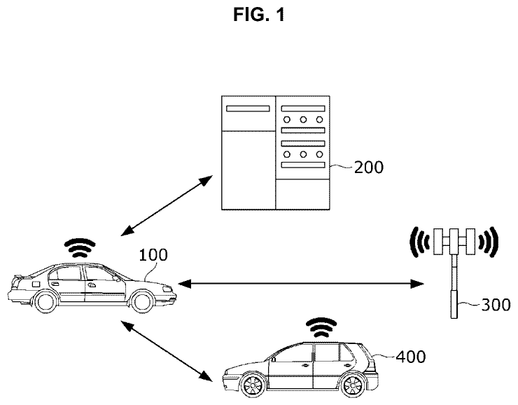

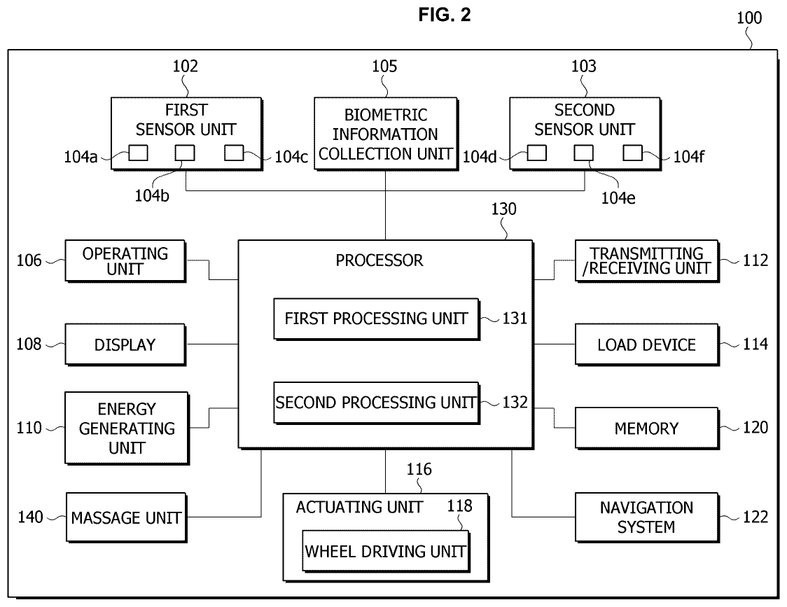

Hereinafter, a vehicle will be described with reference to FIG. 1 and FIG. 2. FIG. 1 is a view illustrating that a vehicle transmits and receives data by communicating with another device.

Referring to FIG. 1, the vehicle 100 may be driven based on electrical energy or fossil energy. In the case of electrical energy, the vehicle 100 may be, for example, a pure battery-based vehicle powered only by a high-voltage battery, or may employ a gas-based fuel cell as an energy source. In addition, the fuel cell may use various types of gas capable of generating electrical energy, and the vehicle 100 may be filled with the gas in a liquefied state, for example. Here, the gas may be hydrogen as one example. However, the gas is not limited thereto, and various gases are applicable. In the case of fossil energy, the vehicle 100 is driven based on fuel such as gasoline, diesel or liquefied gas, and may be equipped with an internal combustion engine that drives an actuating unit 116 by combustion of the fuel. The engine may be included in an energy generating unit 110 in terms of providing a driving rotational force of wheels to a wheel driving unit 118. As another example, the vehicle 100 may drive the actuating unit 116 by selectively utilizing energy from a fossil energy-based internal combustion engine and an electric battery, and may be a hybrid type vehicle.

The vehicle 100 may refer to a movable device. The vehicle 100 is a ground vehicle that travels on the ground and may be a typical passenger car, a commercial vehicle, a purpose-built vehicle (PBV), or the like. The vehicle 100 may be a four-wheeled vehicle, such as a passenger car, a sport utility vehicle (SUV), or a small truck, or may be a vehicle with more than four wheels, such as a bus, a large truck, a container transport vehicle, a heavy equipment vehicle, or the like. Here, the ground vehicle may be referred to as including a vehicle that moves underground as well as a vehicle that moves over land. The vehicle 100 may be a robot in a broad sense, such as a means of movement, and the robot may be moved using wheels, tracks, or other movement modules. In the present disclosure, ground mobility devices such as ground vehicles are mainly described, but unless otherwise inconsistent with the present disclosure, the present embodiment may also be applied to air mobility devices such as AAMs, aircraft, or the like, and water mobility devices such as ships, submarines, or the like.

The vehicle 100 may be controlled and driven by autonomous driving, and the autonomous driving may be implemented as semi-autonomous driving or fully autonomous driving. Fully autonomous driving may be provided as autonomous movement in which a processor 130 of the vehicle 100 takes full control without user intervention, even when a driving situation is uncertain. Semi-autonomous driving may be provided as autonomous movement that requires driver intervention depending on specific driving situations. Semi-autonomous driving may be implemented so that the processor 130 transfers control to a user while deactivating autonomous driving when the aforementioned situation occurs, allowing the user to perform manual driving. According to the levels of autonomous driving defined by the Society of Automotive Engineers (SAE), semi-autonomous driving may correspond to autonomous driving levels 1 to 4, and fully autonomous driving may correspond to level 5.

Meanwhile, the vehicle 100 may communicate with other devices 200 and 300 or another vehicle 400. Other devices may include, for example, a server 200 that supports various controls, state management, and driving of the vehicle 100, an intelligent transportation system (ITS) device 300 for receiving information from an ITS, various types of user devices, or the like. The server 200 may be, for example, an external device operated by a vehicle manufacturer or provided to service autonomous driving, and may receive connected data of the vehicle 100 or transmit data necessary for autonomous driving. The server 200 may transmit various information and software modules used to control the vehicle 100 to the vehicle 100 in response to the request and data transmitted from the vehicle 100 and the user device to support autonomous driving and various services of the vehicle 100.

The ITS device 300 may be, for example, a roadside unit (RSU), and the ITS device 300 may assist the user in driving his or her own vehicle or support autonomous driving of the vehicle 100 by exchanging vehicle recognition data, driving control and state data, environmental data around the vehicle, map data, or the like, through vehicle-to-infrastructure (V2I) communication with the vehicle 100. The vehicle 100 may support manual driving or autonomous driving by exchanging the data listed above through V2V with the other vehicle 400.

The vehicle 100 may communicate with other vehicles or other devices based on cellular communication, wireless access in vehicular environment (WAVE) communication, dedicated short range communication (DSRC), or short-range communication, or other communication methods.

For example, the vehicle 100 may use a cellular communication network such as LTE or 5G, WiFi communication network, WAVE communication network, or the like, for communication with the server 200, the ITS device 300, and the other vehicle 400. For another example, DSRC or the like used in the vehicle 100 may be used for communication between vehicles. The communication method between the vehicle 100, the server 200, the ITS device 300, the other vehicle 400, and the user device is not limited to the above-described embodiment.

FIG. 2 is a diagram showing modules constituting the vehicle according to one embodiment of the present disclosure.

The vehicle 100 may include a sensor unit 102, an operating unit 106, a display 108, a load device 114, and a transmitting/receiving unit 112.

The sensor unit 102 may be provided with various types of detectors to detect various states and situations occurring in an external environment, an internal system, a user operation, and a boarding space of the vehicle 100.

Specifically, a first sensor unit 102 may be provided with an externally oriented camera 104a, a lidar sensor 104b, a radar sensor 104c, and the like, to recognize dynamic and static objects existing outside the vehicle 100. The camera 104a may recognize an external object as an image while the vehicle 100 is in use, generate image data, and transmit the image data to the processor 130. The lidar sensor 104b may generate point cloud data as recognized data of the external object and transmit the point cloud data to the processor 130 to generate 3D spatial information that identifies at least a shape of the external object. In order to ascertain the presence of an external object and its relative distance, speed, direction, or the like, the radar sensor 104c may emit radio waves of a specific frequency around the vehicle 100 and generate radar data through radio waves reflected from the external object. In the present disclosure, the sensor unit is illustrated as having the lidar sensor 104b, but in other examples, the lidar sensor 104b may not be mounted.

The first sensor unit 102 may generate object recognition information based on sensing data. Object recognition information may include information on the existence of an object, position information about the object, information on a distance between the vehicle 100 and the object, and information on a relative speed between the vehicle 100 and the object. In the embodiment, external objects may be various objects related to the operation of the vehicle 100.

In addition, the first sensor unit 102 may include a plurality of cameras that photograph the interior of the vehicle and a microphone that collects interior voice information of the vehicle. The first sensor unit 102 may capture images of the interior of the vehicle to generate image information and generate voice information using voice signals detected inside the vehicle.

A second sensor unit 103 may be provided with a positioning sensor 104d, a wheel sensor 104e, an attitude sensor 104f, and the like, to confirm its own location, speed, driving attitude, and the like. The attitude sensor 104f may include a gyro sensor, an angular velocity sensor, an acceleration sensor, or the like. The attitude sensor may be an inertial measurement unit (IMU) sensor and may be equipped with a 3-axis accelerometer and a 3-axis gyroscope. The attitude sensor may measure acceleration in a traveling direction (x), acceleration in a lateral direction (y), acceleration in a height direction (z) of the vehicle 100, and a yaw, a pitch, and a roll as the angular velocity of the vehicle.

The second sensor unit 103 may generate vehicle traveling information based on sensing data. The vehicle traveling information may be information generated based on data detected by various sensors installed inside the vehicle. For example, the vehicle traveling information may include vehicle attitude information, vehicle speed information, vehicle inclination information, vehicle weight information, vehicle direction information, vehicle battery information, vehicle fuel information, vehicle tire pressure information, vehicle steering information, vehicle interior temperature information, vehicle interior humidity information, pedal position information, vehicle engine temperature information, and the like.

A biometric information collection unit 105 may be provided in a head mounted device and a vibration seat to collect biometric information about an occupant experiencing virtual environment driving content.

For example, the biometric information collection unit 105 may be provided in the vibration seat to measure a heart rate of the occupant.

In addition, the vehicle traveling information may include route information. The route information may refer to information generated based on a destination input by a vehicle user through the operating unit 106. The route information may refer to information that indicates a traveling route from a current vehicle position to a destination on a map when the destination has been set. When no destination is set, the route information may refer to information including a road on which a host vehicle is currently traveling and a future driving route including the road.

The operating unit 106 may be configured as a module controlled by the user for driving. For example, the operating unit 106 may be a steering wheel for manual driving, an automatic or manual shift transmission, an accelerator pedal, a brake pedal, or the like. The operating unit 106 may be further provided with an interface for enabling or disabling an autonomous driving mode and selecting detailed functions requested by the user so that the user may use the autonomous driving function. In order to receive various requests related to autonomous driving, the operating unit 106 may be configured, for example, as a hard-type interface provided at a predetermined position inside the vehicle 100, or as a soft-type interface that capable of being touched on the display 108. Depending on the specifications of the autonomous vehicle, at least one of the steering wheel, the transmission, and the pedal may be omitted. For another example, the operating unit 106 may be provided with a module that receives a user's control request for the load device 114 in addition to driving control.

The display 108 may function as a user interface. The display 108 may output and display an operating state, a control state, route/traffic information, remaining energy amount information, content requested by the driver, or the like, of the vehicle 100 by the processor 130. In addition, the display 108 may be configured as a touch screen capable of detecting driver input to receive a driver's request to instruct the processor 130.

The load device 114 is mounted on the vehicle 100 and may be a type of non-driving electric device excluding a driving power system such as the wheel driving unit 118 or the like. The load device 114 is an auxiliary device that receives electric power from the energy generating unit 110, and may be, for example, an air conditioning system, a lighting system, a seat system, various devices installed in the vehicle 100, or the like. In the present disclosure, a cooling/heating system that cools or heats at least one of the battery, the fuel cell, the internal combustion engine, the air conditioning system, and a specific part of the vehicle 100 may be further included.

The transmitting/receiving unit 112 may support mutual communication with the server 200, the ITS device 300, surrounding vehicles 300, and the like. The transmitting/receiving unit 112 may include a module that processes, for example, cellular communication, WAVE, DSRC communication, and the like. In the present disclosure, the transmitting/receiving unit 112 may transmit data generated or stored while driving to the server 200 and receive data and software modules transmitted from the server 200. The transmitting/receiving unit 112 may support communication with an electronic device carried by an occupant inside the vehicle 100. In the present disclosure, the vehicle 100 may transmit and receive data utilized in a method according to the present disclosure to the outside through the transmitting/receiving unit 112.

For example, the transmitting/receiving unit 112 may receive traffic signal information from a traffic signal controller and provide the traffic signal information to the processor 130. In addition, the transmitting/receiving unit 112 may receive a control signal from the traffic signal controller and provide the control signal to the processor 130.

In addition, the vehicle 100 may include an energy generating unit 110 and an actuating unit 116.

The energy generating unit 110 may generate and supply power and electric power used in a driving power system and a non-driving power system, such as the actuating unit 116. The non-driving power system may be, for example, the sensor unit 102, the operating unit 106, the display 108, the load device 114, and the transmitting/receiving unit 112, but is not limited thereto, and may include various components that implement sensing, interface, communication, and convenience functions, excluding components directly involved in driving operations. When the vehicle 100 is driven based on electrical energy, the energy generating unit 110 may be configured as an electric battery charged from the outside, or configured as a combination of an electric battery and a fuel cell that charges the electric battery. In the case of the combination of the electric battery and the fuel cell, the energy generating unit 110 may include a tank that stores materials used to produce electric power for the fuel cell, such as liquefied hydrogen. When the vehicle 100 is driven based on fossil energy, the energy generating unit 110 may be configured as the internal combustion engine. In addition, when the vehicle 100 is a hybrid type, the energy generating unit 110 may be provided as a combination of the internal combustion engine and the electric battery.

The actuating unit 116 may be provided with at least one module that implements driving operations and perform at least one driving operation among longitudinal control such as acceleration and deceleration and lateral control such as steering, according to a user request from the operating unit 106. In order to perform driving operations according to a command of the processor 130 by a manual operation of the user or autonomous driving, the actuating unit 116 may be provided with the wheel driving unit 118 and mechanical components and electronic modules for implementing the driving operations in the wheel driving unit 118. When the vehicle 100 is operated based on electric energy, the actuating unit 116 may include an assembly for transmitting the requested driving operation to the wheel driving unit 118. When the vehicle 100 is operated based on fossil energy, the actuating unit 116 may be provided with a transmission and a gear module that transmit the power of the internal combustion engine.

The wheel driving unit 118 may include a plurality of wheels, a driving force generation module for generating a driving force and applying the driving force to the wheels or transmitting the driving force, a braking module for slowing down the driving of the wheels, and a steering module for carrying out lateral control of the wheels. When the vehicle 100 is driven based on electrical energy, the driving force generating module may be configured as a motor assembly that generates a driving force based on electric power output from the electric battery. The braking module of the electric-based vehicle 100 may further have a regenerative braking function.

A navigation unit 122 may provide navigation information. The navigation information may include at least one of map information, set destination information, route information according to a set destination, information on various objects on the route, lane information, and current vehicle position information.

The navigation unit 122 may receive information from an external device through the transmitting/receiving unit 112 and update previously stored information. According to the embodiment, the navigation unit 122 may be classified as a sub-component of the operating unit 106.

In addition, the vehicle 100 may include a memory 120 and a processor 130.

The memory 120 may store applications and various data for controlling the vehicle 100 and load applications or read and record data by a request of the processor 130.

The processor 130 may perform overall control of the vehicle 100. The processor 130 may be configured to execute applications and instructions stored in the memory 120.

The processor 130 may include a first processing unit 131 and a second processing unit 132.

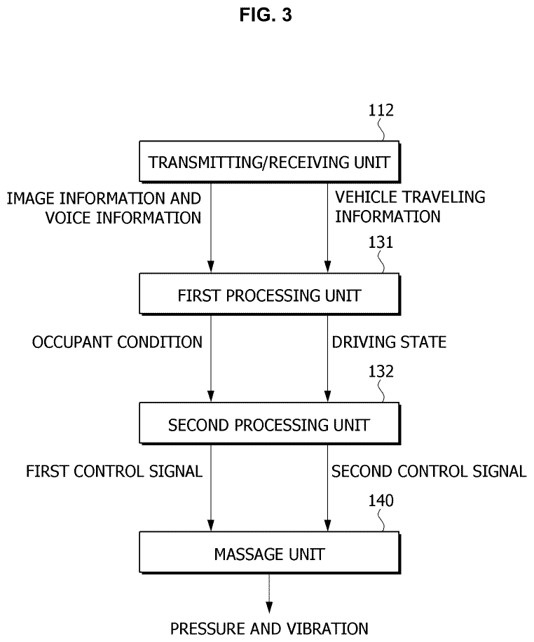

FIG. 3 is a diagram for describing the operation of the vehicle according to the embodiment. Referring to FIG. 3, the massage unit 140 may be mounted on a headrest 20 of the vehicle seat to generate pressure and vibration. The massage unit 140 may provide a massage function to the occupant by operating to generate pressure and vibration according to a control signal of the second processing unit 132.

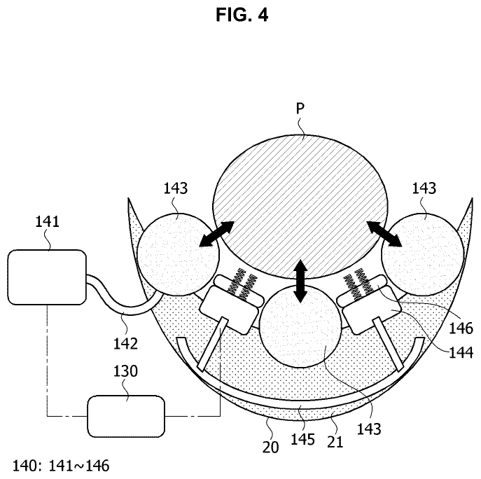

FIG. 4 is a conceptual view of the massage unit according to the embodiment. Referring to FIG. 4 together, the interior of the headrest 20 of the vehicle seat may be filled with a memory foam material 21, and the massage unit 140 may include a pump 141 that adjusts the supply and discharge of air, at least one pneumatic ball 143 that provides pressure to a neck region of an occupant P by contracting and expanding in conjunction with the operation of the pump 141, at least one voice coil motor (VCM) 144 that provides vibration to the neck region of the occupant, a support 145 disposed between one end of the voice coil motor 144 and an inner surface of the headrest 20 to support the voice coil motor 144, and a cushioning member 146 disposed at the other end of the voice coil motor 144.

In the embodiment, a plurality of pneumatic balls 143 and a plurality of voice coil motors 144 may be disposed at predetermined intervals along a neck circumference of the occupant on the headrest 20.

The pump 141 may supply air to the pneumatic ball by compressing or discharging air. The pump 141 may change a massage intensity by adjusting an air pressure.

The pneumatic ball 143 may be a soft ball that serves to massage the neck, have a structure that allows air to be filled inside, and be inflated by air supplied from the pump 141.

The pump 141 and the pneumatic ball 143 may be connected through an air tube 142, and air may freely move through the air tube 142. Compressed air generated from the pump 141 may be transmitted to the pneumatic ball 143 through the air tube.

When the control signal of the second processing unit 132 is generated, the pump 141 operates to compress air, and the compressed air may be delivered to the pneumatic ball 143 through the air tube 142. When the compressed air is injected into the pneumatic ball 143, the pneumatic ball 143 may inflate, and the pneumatic ball 143 may gently press a specific region of the neck to produce a massage effect.

The pump 141 causes the pneumatic ball 143 to repeatedly contract and expand by periodically injecting or discharging air according to the control signal. In this process, the pneumatic ball 143 maximizes the massage effect by performing an operation of repeatedly pressing and releasing the neck muscles, and thus helps to relieve tension in the neck muscles and promote blood circulation.

When the massage ends according to the control signal or the user selects to end according to the control signal, the pump 141 may discharge the air inside the pneumatic ball 143 to make the ball flat again. In this way, the massager may be returned to its original state and the user may remove the device.

The massage function of the pneumatic ball 143 may relieve fatigue of neck muscles, relieve tension, and help the user maintain a comfortable state. The massage function may be especially effective when the massager is used after long drives or office work.

The voice coil motor 144 is a device that generates linear motion (straight-line motion) using electromagnetic principles. The voice coil motor 144 may adjust the intensity and frequency of vibration depending on the direction and size of current. Since the voice coil motor 144 is lightweight and has a fast response speed, the voice coil motor 144 may generate precise vibration despite its small size.

The cushioning member 146 is a portion that directly contacts the neck region and transmits vibration, and is generally made of soft silicone or rubber material so that the cushioning member 146 gently touches the user's skin. The cushioning member 146 may act as a vibration pad and transmit the movement of the voice coil motor 144 to the neck muscles.

The voice coil motor 144 supplies current to the voice coil motor 144 according to the control signal of the second processing unit 132, and the supplied current flows through a coil and interacts with a magnet inside the voice coil motor 144 to generate movement.

The voice coil motor 144 vibrates back and forth depending on a magnitude and direction of the current, and the movement may be transmitted to the cushioning member 146. Since the voice coil motor 144 is capable of very fast and accurate vibration due to its characteristics, the occupant may experience the massage effect at various frequencies and intensities.

The cushioning member 146 may be in close contact with the skin of the neck region to transmit the vibration generated from the voice coil motor 144 to the neck muscles. The vibration may stimulate muscles, promote blood circulation, and relieve fatigue. Certain frequencies of vibration may be particularly effective in relieving muscle tension.

The voice coil motor 144 may provide various vibration patterns according to the control signal of the second processing unit 132. For example, the voice coil motor 144 may provide the vibration at regular intervals or change the intensity and frequency to produce various massage effects.

When the massage is terminated according to the control signal of the second processing unit 132 or the occupant's termination command selection, current supply to the voice coil motor 144 is stopped. By stopping the current supply, the motor stops vibrating, and the device returns to its pre-use state.

The vibration massage function using the voice coil motor 144 may be useful in helping to relieve fatigue of the neck muscles, relieve tension, relieve stress, and so on.

The transmitting/receiving unit 112 may collect image information and voice information about the interior of the vehicle, and traveling information about the vehicle. The transmitting/receiving unit 112 may collect image information generated by photographing the interior of the vehicle from the first sensor unit and voice information generated by detecting voice signals inside the vehicle. In addition, the transmitting/receiving unit 112 may collect vehicle traveling information including speed information, acceleration information, torque information, and accelerator pedal operation information from the second sensor unit.

In the embodiment, the image information may refer to image data of the occupant's face, eye blink frequency, head movement, and the like, captured by a camera installed inside the vehicle.

In the embodiment, the voice information may refer to a voice signal obtained by recording the occupant's voice tone, speech speed, speech interval, and the like, through a microphone inside the vehicle.

The first processing unit 131 may analyze a condition of an occupant and a driving state of the vehicle using the image information and voice information about the interior of the vehicle, and the traveling information about the vehicle.

The first processing unit 131 may determine the condition of the occupant, including physical and emotional conditions of the occupant using the image information and voice information about the interior of the vehicle.

The first processing unit 131 may convert the collected image information and voice information into a form suitable for analysis. For example, from the image information, specific feature points (such as the eyes, mouth, and eyebrows) may be extracted for facial recognition and facial expression analysis, and from the voice information, acoustic features such as voice spectrogram or Mel-frequency cepstral coefficients (MFCC) may be extracted.

The first processing unit 131 may analyze features extracted from an image using a deep learning model (e.g., CNN, R-CNN, Single Shot Multibox Detector, MT-CNN, Mini-Xception, or the like). The deep learning model may predict the physical and emotional conditions of the occupant through the occupant's blink frequency, eye movements, and subtle facial muscle movements, or the like.

The first processing unit 131 may analyze a speed, tone, intonation, and the like, of the occupant's speech based on features extracted from the voice information. The first processing unit 131 may analyze the voice information and predict the physical and emotional conditions of the occupant using models such as natural language processing (NLP), recurrent neural networks (RNN), or long short-term memory (LSTM).

In addition, the first processing unit 131 may determine the driving state using speed information and acceleration information included in the traveling information about the vehicle.

The first processing unit 131 may preprocess the speed information and the acceleration information into an analyzable form. For example, the first processing unit 131 may remove noise from the speed information and the acceleration information, sample data at regular time intervals, and process the data into a form suitable for analysis.

The first processing unit 131 may analyze changes in speed during a certain period of time to determine whether the vehicle is traveling at a certain speed, accelerating, or decelerating.

In addition, the first processing unit 131 may analyze a movement pattern of the vehicle through the acceleration information. For example, as a result of the analysis, the first processing unit 131 may determine that the vehicle is accelerating when the acceleration continuously increases, and may determine that the vehicle is decelerating when the acceleration is a negative number.

The first processing unit 131 may determine the driving state of the vehicle by collectively analyzing the speed information and acceleration information. For example, as a result of the analysis, the first processing unit 131 may determine that the vehicle is in a stopped state when the speed is close to 0. In addition, as the result of the analysis, the first processing unit 131 may determine that the vehicle is in a constant speed driving state when the vehicle is traveling at a constant speed and the change in acceleration is not large. In addition, as the result of the analysis, the first processing unit 131 may determine that the vehicle is in an acceleration driving state when the vehicle speed increases and the acceleration is positive. In addition, as the result of the analysis, the first processing unit 131 may determine that the vehicle is in a deceleration state when the vehicle speed decreases and the acceleration is negative. In addition, as the result of the analysis, the first processing unit 131 may determine that the vehicle is in a state of rapid acceleration or in a state of rapid deceleration when the acceleration significantly changes beyond a certain threshold value.

In addition, the first processing unit 131 may determine the physical condition of the occupant using the acceleration information and the accelerator pedal operation information included in the traveling information about the vehicle. The first processing unit 131 may determine the physical condition of the occupant by analyzing the magnitude of acceleration, an accelerator pedal operation amount, and the number of operations. For example, the first processing unit 131 may increase a fatigue level of the occupant when the magnitude of the acceleration is 1G or greater and the number of times the accelerator pedal is repeatedly operated is 10 or more during a predetermined period of time.

Alternatively, the first processing unit 131 may increase the fatigue level of the occupant when the accelerator pedal operation amount is 20% or more and the number of times the accelerator pedal is repeatedly operated is 10 or more during the predetermined period of time.

The second processing unit 132 may control the operation of the massage unit 140 using the condition of the occupant and the driving state of the vehicle.

The second processing unit 132 may generate a first control signal for controlling a pressure intensity and an expansion cycle of the pneumatic ball 143 depending on the condition of the occupant and the driving state of the vehicle.

For example, the second processing unit 132 may generate the first control signal by dividing the pressure intensity into a plurality of levels.

In addition, the second processing unit 132 may generate the first control signal by dividing the expansion cycle into a plurality of speeds.

The second processing unit 132 may generate a second control signal for controlling the vibration intensity, vibration frequency, and vibration pattern of the voice coil motor 144 depending on the condition of the occupant and the driving state of the vehicle.

For example, the second processing unit 132 may generate the second control signal by dividing the vibration intensity into a plurality of levels.

In addition, the second processing unit 132 may generate the second control signal having a specific vibration pattern by setting a range of vibration frequencies.

For example, when the occupant is in a happy emotional condition, the second processing unit 132 may provide a massage function accompanied by vibrations of a relatively high frequency together with weak pressure, thereby doubling the occupant's pleasure through light stimulation.

Alternatively, when the occupant is in a depressed emotional condition, the second processing unit 132 may provide a massage function having only soft pressure without vibration so as not to stimulate the occupant, thereby giving a feeling of being cared for.

Alternatively, when the occupant is physically tired, the second processing unit 132 may provide a massage function to relieve fatigue through slow but strong pressure and vibration.

Alternatively, when the occupant is in a physical condition that is expected to drive while drowsy, the second processing unit 132 may provide a massage function to arouse the attention of the occupant by maintaining strong pressure and at the same time, strongly generating a beat-like vibration of a pattern similar to a warning signal at a high frequency.

Alternatively, when the vehicle is in a stopped or low-speed driving state, the second processing unit 132 may provide a massage function in which appropriate pressure and low frequency vibration are combined, thereby creating a comfortable resting environment.

Alternatively, when the vehicle is in a high-speed driving state, the second processing unit 132 may provide a massage function in which strong pressure and high-frequency vibration are combined to create a sporty feeling, thereby allowing the driver to experience the pleasure of dynamic driving.

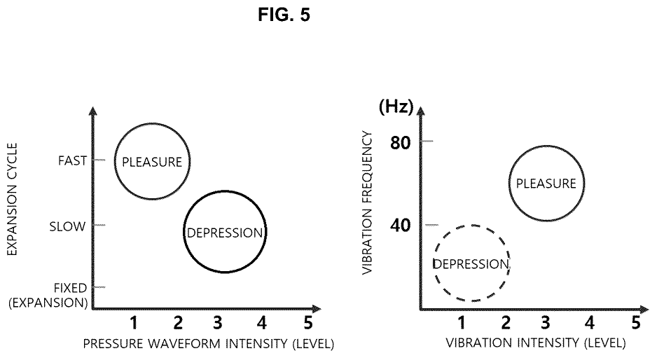

FIGS. 5 to 11 are views for describing the operation of a processor according to the embodiment.

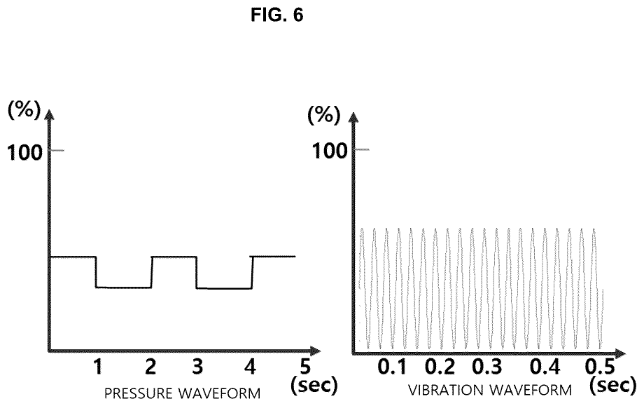

Referring to FIGS. 5 and 6 together, the first processing unit 131 may classify an emotional condition of the occupant into pleasure, depression, and calmness.

When the emotional condition of the occupant is pleasure, the second processing unit 132 may set a pressure waveform intensity to a low level and generate a first control signal to have a fast expansion cycle. In addition, the second processing unit 132 may set the vibration intensity to an intermediate level and generate a second control signal to have a sine wave of a high vibration frequency (approximately 40 to 80 Hz). When the emotional condition of the occupant is pleasure, the first control signal and the second control signal may be generated as shown in FIG. 6.

When the emotional condition of the occupant is depression, the second processing unit 132 may set the pressure waveform intensity to an intermediate level and generate the first control signal to have a slow expansion cycle. In addition, the second processing unit 132 may set the vibration intensity to a weak level and generate the second control signal to have a low vibration frequency (approximately 10 to 30 Hz).

When the emotional condition of the occupant is calmness, the second processing unit 132 may generate the control signals depending on the physical condition, driving state, and the like.

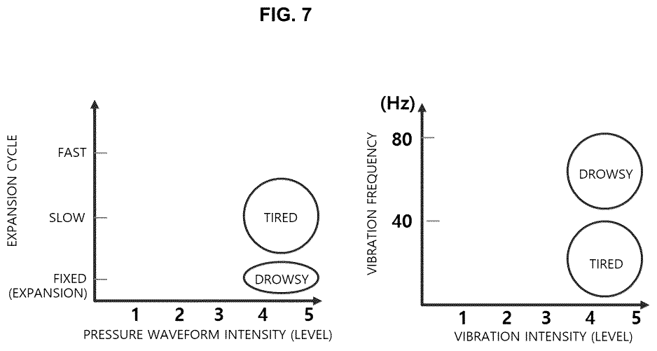

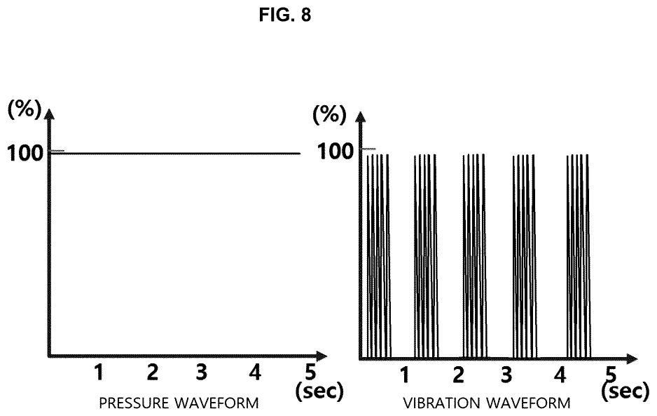

Referring to FIGS. 7 and 8 together, the first processing unit 131 may classify the physical condition of the occupant into normal, tired, and drowsy states.

When the physical condition of the occupant is in the drowsy state, the second processing unit 132 may set the pressure intensity to a high level and generate the first control signal to maintain an expansion state. The second processing unit 132 may set the vibration intensity to a high level and generate the second control signal of a beat pattern having a high vibration frequency. When the physical condition of the occupant is in the drowsy state, the first control signal and the second control signal may be generated as shown in FIG. 8.

When the physical condition of the occupant is in the tired state, the second processing unit 132 may set the pressure intensity to the high level and generate the first control signal to have a slow expansion cycle. The second processing unit 132 may set the vibration intensity to the high level and generate the second control signal to have a sine wave of a low vibration frequency.

When the physical condition of the occupant is in the normal condition, the second processing unit 132 may generate the control signals depending on the emotional condition, driving state, and the like.

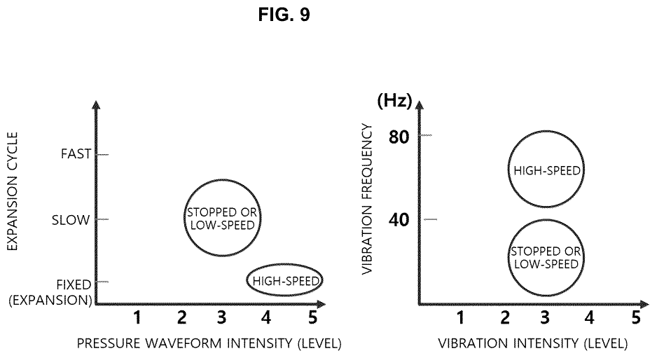

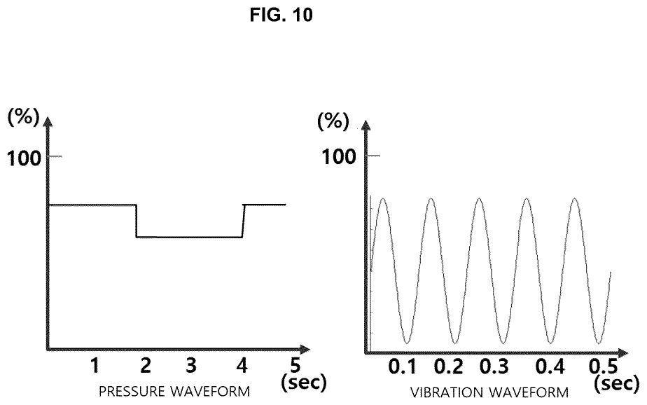

Referring to FIGS. 9 and 10 together, the first processing unit 131 may divide the driving state into a stopped or low-speed driving state and a high-speed driving state.

When the driving state is the stopped or low-speed driving state, the second processing unit 132 may set the pressure intensity to the intermediate level and generate the first control signal to have a slow expansion cycle. The second processing unit 132 may set the vibration intensity to the intermediate level and generate the second control signal to have a sine wave of a low vibration frequency. When the driving state of the vehicle is the stopped or low-speed driving state, the first control signal and the second control signal may be generated as shown in FIG. 10.

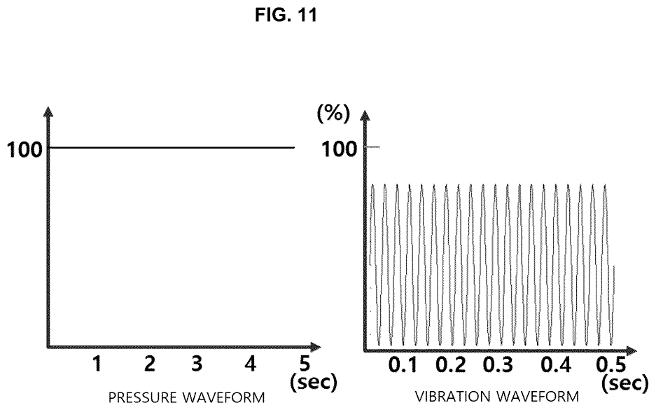

When the driving state is the high-speed driving state, the second processing unit 132 may set the pressure intensity to the high level and generate the first control signal to maintain the expansion state. The second processing unit 132 may set the vibration intensity to the intermediate level and generate the second control signal to have a sine wave of a high vibration frequency. When the driving state of the vehicle is the high-speed driving state, the first control signal and the second control signal may be generated as shown in FIG. 11.

The second processing unit 132 may generate the control signals for driving the massage unit 140 by adjusting the pressure intensity, expansion cycle, vibration intensity, vibration frequency, and the like, depending on the emotional and physical conditions of the occupant and the driving state of the vehicle, as shown in FIGS. 5 to 7. To summarize, the above may be summarized as in Table 1 below.

TABLE 1

| | Passenger | | | | |
|---|---|---|---|---|---|
| | state | | | | |
| | analysis | | | | |
| | results: | Driving | | Vibration | |
| | use of | state | | waveform | |
| | passenger | analysis | | to be | |
| | camera | results: | Pressure waveform | provided: | |
| | and | use of | to be provided: | use of | |
| | microphone | vehicle | use of air | voice coil | Expected |
| Scenario | (10) | ECU (20) | pump (1) | motor (1) | effect |
| 1 | Pleasure | — | Pressure intensity: | Vibration | Pleasure |
| | mood | | weak | intensity: | doubled |
| | | | Contraction/ | intermediate | |
| | | | expansion cycle: | Vibration | |
| | | | fast | frequency: | |
| | | | | high (40 | |
| | | | | to 80 Hz) | |
| | | | | Vibration | |
| | | | | pattern: | |
| | | | | sine wave | |
| 2 | Depressed | — | Pressure intensity: | Vibration: | Giving |
| | mood | | intermediate | none | feeling |
| | | | Contraction/ | | of care |
| | | | expansion cycle: | | |
| | | | slow | | |
| 3 | When | When | Pressure intensity: | Vibration | Relieving |
| | body is | body is | strong | intensity: | fatigue |
| | tired | tired | Contraction/ | strong | |
| | | (determining | expansion cycle: | Vibration | |
| | | by | slow | frequency: | |
| | | acceleration, | | low (10 | |
| | | accelerator | | to 30 Hz) | |
| | | pedal | | Vibration | |
| | | operation | | pattern: | |
| | | amount, and | | sine wave | |
| | | cumulative | | | |
| | | number of | | | |
| | | accelerator | | | |
| | | pedal | | | |
| | | operations) | | | |
| 4 | When | — | Pressure intensity: | Vibration | Alerting |
| | driver is | | strong | intensity: | and |
| | expected | | Maintaining only | strong | drawing |
| | to drive | | expansion | Vibration | attention |
| | while | | | frequency: | |
| | drowsy | | | high (40 | |
| | | | | to 80 Hz) | |
| | | | | Vibration | |
| | | | | pattern: | |
| | | | | beat | |
| | | | | waveform | |
| | | | | (e.g., 2 | |
| | | | | seconds | |
| | | | | on, 1 | |
| | | | | second off | |
| | | | | repeatedly) | |
| 5 | — | When | Pressure intensity: | Vibration | Providing |
| | | stopped or | intermediate | intensity: | feeling |
| | | driving at | Contraction/ | intermediate | of |
| | | low speed | expansion change | Vibration | comfort |
| | | (traffic | cycle: slow | frequency: | |
| | | jam, etc.) | | low (10 | |
| | | | | to 30 Hz) | |
| | | | | Vibration | |
| | | | | pattern: | |
| | | | | sine wave | |
| 6 | — | When | Pressure intensity: | Vibration | Providing |
| | | driving at | strong | intensity: | sporty |
| | | high speed | Maintaining only | intermediate | feeling |
| | | | expansion | Vibration | and |
| | | | | frequency: | driving |
| | | | | high (40 | pleasure |
| | | | | to 80 Hz) | |
| | | | | Vibration | |
| | | | | pattern: | |
| | | | | sine wave | |

In addition, the second processing unit 132 may adjust the pressure of the pneumatic ball 143 inversely proportional to the acceleration depending on the driving state. When the acceleration of the vehicle is high, inertia may cause the occupant to experience a force in the opposite direction of travel. Accordingly, the second processing unit 132 may adjust the pressure of the pump 141 depending on the acceleration magnitude of the vehicle. The second processing unit 132 may generate the first control signal to reduce the pressure of the pneumatic ball 143 depending on the acceleration magnitude of the vehicle. Through the generation of the first control signal, it is possible to prevent a situation in which the occupant is subjected to excessive pressure by the pneumatic ball 143 in the high acceleration situation.

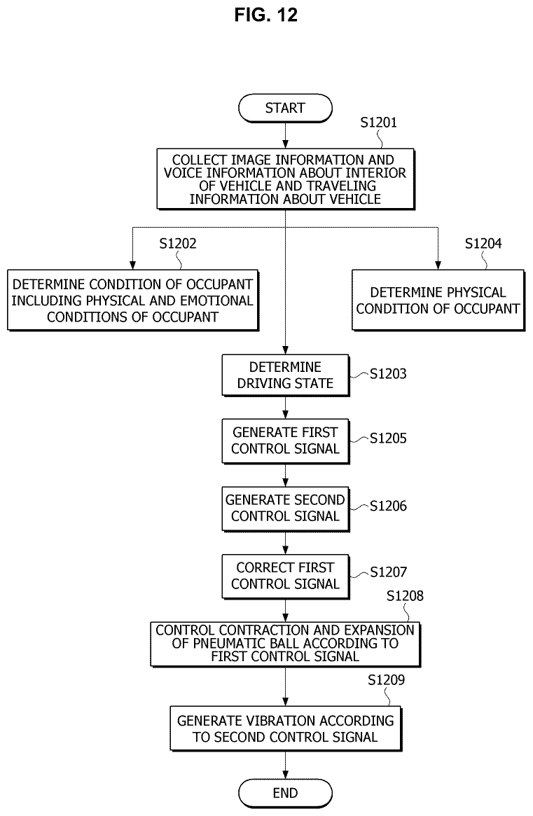

FIG. 12 is a flowchart of a method of controlling a vehicle according to an embodiment.

Referring to FIG. 12, the transmitting/receiving unit collects image information and voice information about the interior of the vehicle and traveling information about the interior of the vehicle (S1201).

Next, the first processing unit 131 determines a condition of an occupant including physical and emotional conditions of the occupant using the image information and voice information about the interior of the vehicle (S1202).

In addition, the first processing unit determines the driving state using speed information and acceleration information included in the traveling information about the vehicle (S1203).

In addition, the first processing unit determines the physical condition of the occupant using the acceleration information and accelerator pedal operation information included in the traveling information about the vehicle (S1204).

Next, the second processing unit generates a first control signal to control a pressure intensity and expansion cycle of the pneumatic ball depending on the condition of the occupant and the driving state of the vehicle (S1205).

Subsequently or simultaneously, the second processing unit generates a second control signal for controlling the vibration intensity, vibration frequency, and vibration pattern of the voice coil motor depending on the condition of the occupant and the driving state of the vehicle (S1206).

Next, the second processing unit corrects the first control signal by adjusting pressure of the pneumatic ball inversely proportional to acceleration depending on the driving (S1207).

Next, a pump of a massage unit controls contraction and expansion of the pneumatic ball by being driven according to the first control signal to (S1208).

Subsequently or simultaneously, the voice coil motor of the massage unit generates vibration by being driven according to the second control signal (S1209).

The term “unit” used in the present embodiment refers to software component or hardware components such as a field-programmable gate array (FPGA) or an application specific integrated circuit (ASIC), and “unit” performs certain functions. However, the “˜unit” is not limited to software or hardware. The “˜unit” may be configured to reside in an addressable storage medium, or may be configured to reproduce one or more processors. Therefore, for example, “unit” includes components such as software components, object-oriented software components, class components, and task components, and includes processes, functions, attributes, procedures, sub-routines, segments of program code, drivers, firmware, micro codes, circuits, data, a database, data structures, tables, arrays, and variables. Functions provided in the components and the “unit” may be coupled with lesser numbers of components and “units,” or may be further divided into additional components and “units.” Furthermore, the components and “˜units” may be implemented to reproduce one or more CPUs in a device or a security multimedia card.

With a vehicle according to an embodiment and a method of controlling the same, it is possible to provide a customized vibration depending on a driving situation, fatigue of an occupant, a physical condition, and the like.

In this way, it is possible to provide a more effective and satisfactory massage experience to the vehicle occupant.

Although the preferred embodiments of the present disclosure have been described above, it is understood that those skilled in the art can make various changes and modifications to the present disclosure without departing from the spirit and scope of the present disclosure set forth in the claims below.

What is claimed is:

1. A vehicle comprising:
a massage unit mounted on a headrest of a vehicle seat to generate pressure and vibration;
a transmitting/receiving unit configured to collect image information and voice information about an interior of a vehicle and traveling information about the vehicle; and
at least one processor configured to:
analyze a condition of an occupant and a driving state of the vehicle using the image information and voice information about the interior of the vehicle and the traveling information about the vehicle; and
control an operation of the massage unit using the condition of the occupant and the driving state of the vehicle.

2. The vehicle of claim 1, wherein the massage unit includes:
a pump configured to adjust supply and discharge of air;
at least one pneumatic ball configured to provide the pressure to a neck region of the occupant by contracting and expanding in conjunction with an operation of the pump; and
at least one voice coil motor configured to provide the vibration to the neck region of the occupant.

3. The vehicle of claim 2, wherein the massage unit further includes:
a support disposed between one end of the voice coil motor and an inner surface of the headrest to support the voice coil motor; and
a cushioning member disposed at the other end of the voice coil motor.

4. The vehicle of claim 2, wherein an interior of the headrest is filled with a memory foam material.

5. The vehicle of claim 2, wherein the at least one processor generates a first control signal for controlling a pressure intensity and an expansion cycle of the pneumatic ball depending on the condition of the occupant and the driving state of the vehicle.

6. The vehicle of claim 2, wherein the at least one processor generates a second control signal for controlling a vibration intensity, a vibration frequency, and a vibration pattern of the voice coil motor depending on the condition of the occupant and the driving state of the vehicle.

7. The vehicle of claim 1, wherein the at least one processor determines the condition of the occupant including physical and emotional conditions of the occupant using the image information and voice information about the interior of the vehicle.

8. The vehicle of claim 1, wherein the at least one processor determines the driving state using speed information and acceleration information included in the traveling information about the vehicle.

9. The vehicle of claim 1, wherein the at least one processor determines a physical condition of the occupant using acceleration information and accelerator pedal operation information included in the traveling information about the vehicle.

10. The vehicle of claim 2, wherein the at least one processor adjusts the pressure of the pneumatic ball inversely proportional to acceleration depending on the driving state.

11. A method of controlling a vehicle, comprising:
collecting, by a transmitting/receiving unit, image information and voice information about an interior of a vehicle and traveling information about the vehicle;
analyzing, by at least one processor, a condition of an occupant and a driving state of the vehicle using the image information and voice information about the interior of the vehicle and the traveling information about the vehicle; and
controlling, by the at least one processor, an operation of a massage unit disposed on a headrest of a vehicle seat using the condition of the occupant and the driving state of the vehicle.

12. The method of claim 11, wherein the massage unit includes:
a pump configured to adjust supply and discharge of air;
at least one pneumatic ball configured to provide pressure to a neck region of the occupant by contracting and expanding in conjunction with an operation of the pump; and
at least one voice coil motor configured to provide vibration to the neck region of the occupant.

13. The method of claim 12, wherein the massage unit further includes:
a support disposed between one end of the voice coil motor and an inner surface of the headrest to support the voice coil motor; and
a cushioning member disposed at the other end of the voice coil motor.

14. The method of claim 12, wherein an interior of the headrest is filled with a memory foam material.

15. The method of claim 12, wherein controlling the operation of the massage unit includes generating a first control signal for controlling a pressure intensity and an expansion cycle of the pneumatic ball depending on the condition of the occupant and the driving state of the vehicle.

16. The method of claim 12, wherein controlling the operation of the massage unit includes generating a second control signal for controlling a vibration intensity, a vibration frequency, and a vibration pattern of the voice coil motor depending on the condition of the occupant and the driving state of the vehicle.

17. The method of claim 11, wherein the analyzing includes determining the condition of the occupant including physical and emotional conditions of the occupant using the image information and voice information about the interior of the vehicle.

18. The method of claim 11, wherein the analyzing includes determining the driving state using speed information and acceleration information included in the traveling information about the vehicle.

19. The method of claim 11, wherein the analyzing includes determining a physical condition of the occupant using acceleration information and accelerator pedal operation information included in the traveling information about the vehicle.

20. The method of claim 12, wherein controlling the operation of the massage unit includes adjusting the pressure of the pneumatic ball inversely proportional to acceleration depending on the driving state.
